(19) United States
(12) Patent Application Publication
(10) Pub. No.: US 2009/0225756 A1
(43) Pub. Date: Sep. 10, 2009

(54) INFORMATION TRANSMISSION SYSTEM

(75) Inventor: Frederique Povert-Becq, Vieillevigne (FR)

Correspondence Address: PATTERSON, THUENTE, SKAAR & CHRISTENSEN, P.A., 4800 IDS CENTER, 80 SOUTH 8TH STREET, MINNEAPOLIS, MN, 55402-2100, US

(73) Assignee: CENTRE NATIONAL D'ETUDES SPATIALES, Paris Cedex 01 (FR)

(21) Appl. No.: 12/096,775

(22) PCT Filed: Dec. 8, 2006
(86) PCT No.: PCT/FR06/02690

§ 371 Date: Oct. 17, 2008

(30) Foreign Application Priority Data
Dec. 8, 2005 (FR) 0512494

(51) Int. Cl. H04L 12/56

(52) U.S. Cl. 370/392

(57) ABSTRACT

An information transmission system, includes: a local area network having a communication module, a capture module for picking up the headers of frames exchanged by way of the communication module, a programming module adapted to control the capture of the frame headers and the transmission of the headers captured as a function of predefined conditions, a transmission module for transmitting the captured headers, by way of the communication module, an analysis device remote from the local area network, suitable for communicating with the local area network by way of the communication module and comprising an analysis module suitable for carrying out a statistical analysis of the headers transmitted by the transmission module.

The present application is a National Phase entry of PCT Application No. PCT/FR2006/002690, filed Dec. 8, 2006, which claims priority from French Application Number 0512494, filed Dec. 8, 2005, the disclosures of which are hereby incorporated by reference herein in their entirety.

### TECHNICAL FIELD

The invention relates to telecommunications and, in particular, data transmission to a geographically isolated zone or data transmission from the geographically isolated zone, hereinafter referred to as “isolated zone” or “isolated site.”

### BACKGROUND

An increasing number of users are opting for a high-speed xDSL connection by way of a telephone network. Such connections are typically offered primarily in urban areas, where the connection equipment can be cost-effective. Certain more isolated zones, for example in rural areas, do not include a sufficient number of users to enable the operators to amortize the equipment for these types of connections.

In another example, a serviced and isolated geographic area relates to densely-populated urban zones regularly connected to:
wireless telecommunication networks, for example, GSM and/or UMTS type telephone networks,
wired telecommunication networks, for example fixed telephone networks or cable telecommunication networks, or
satellite telecommunication networks.

of which at least part of the infrastructures cited is at least partially out of service, for example following a large-scale natural disaster and/or situation of force majeure such as an earthquake, fire, flood, snowstorm, or war.

To provide a high-speed connection in certain isolated zones, high-speed connection projects in these zones, for example, by way of satellites have been launched. A communication module, by satellite for example, then provides a high-speed connection to a local user network. To better adapt such service to needs, and to better estimate sizing of telecommunication equipment required for network implementation, or to determine viability, studies concerning the details of data exchanged between the local user network and a remote network, for example a global Internet network, are desirable (traffic, types of protocols used . . . ). Given the distance and/or reduced accessibility of the different zones serviced and/or isolated, intervention of a technician to perform measurements of the local user network is problematic, if not impossible, since the technician takes measurements only a periodic basis and has only limited methods of analysis. Likewise, a technician is forced to perform the studies concerning the details of data exchanged between the local user network and the remote network by soliciting a communication module. The communication module's capacities may be attributed on a priority basis, or as little as possible, for example, to the transfer of privileged content, independent of the type (satellite, wire, wireless) of linking used by the communication module to link, for example selectively as a function of a rate of infrastructure availability, the local user network in the isolated zone and the remote network.

### SUMMARY OF THE INVENTION

The invention seeks to provide a solution to the aforementioned problems. Thereby the invention relates to an information transmission system, that includes at least a local network linked via a communication module to a remote network remote from the local network, wherein the remote network includes an analysis device that includes at least one statistical information analysis module stemming from the local network. The information transmission system includes at least one autonomous capture station communicatively coupled to the local network. The autonomous capture station includes:
a capture module adapted to capture frame headers exchanged between the local network and the remote network by way of a communication module, wherein the capture of frame headers operates transparently for users of the local network,
a transmission module adapted to communicate to the remote network by way of the communication module frame headers captured by the capture module
a programming module adapted to autonomously control capture of frame headers by the capture module and the transmission of captured frame headers by the transmission module according to at least one predefined condition, and

Wherein information originating from the local network destined for the statistical analysis module includes frame headers transmitted by the transmission module.

According to various aspects of the invention, it is possible to better meet user needs. Statistical analysis of information coming from the local network, for example enabling identification of a specific local demand in terms of a volume of images transmitted between the local network in the isolated zone and the global network for predetermined purposes (for example: videoconference to permit a remote surgeon to help a firefighter located in the isolated zone to practice emergency surgery; advertising), may be achieved without soliciting a communication module several times for the same specific request. In addition, since the capture station is autonomous, its operation does not require any instruction from the outside, or any a priori knowledge of the remote network. The capture station can therefore operate independently without any intervention by a remote technician. Likewise, the system according to the invention may be used in a manner totally independent of telecommunication network operators (e.g. satellite, wire, wireless). In addition, since the capture of frame headers takes place by way of the autonomous capture station transparent to local network users, local network users may be released (for example: firefighters present on site in the isolated zone following an earthquake in charge of saving human lives) from tasks that are unfamiliar to them (these tasks are the province of a technician with expertise in sizing telecommunication equipment).

According to another embodiment, the capture module includes at least one reading sub-module adapted to read frame headers exchanged between the local network and the remote network by way of the communication module.

This embodiment may include the added benefit of capturing the frame headers without storing them, instead they are simply read. This reading function alone is less intensive in terms of energy than the reading function accompanied by writing of the corresponding data in a storage memory, and therefore promotes an economizing of energy and further improves the autonomy of the autonomous capture station.

According to another embodiment, the capture module includes at least one data storage sub-module adapted to store frame headers exchanged between the local network and the remote network by way of the communication module.

According to this embodiment, frame headers may be stored in the data storage sub-module. It therefore becomes possible to then transmit information relating to frame headers via the transmission module to the remote network not only “one by one” but also by packets. Thus, the communication module is solicited as little as possible.

According to another embodiment, the data storage sub-module is at least one flash memory.

According to this embodiment, frame headers are therefore stored in memory having a cellular structure, i.e. having the characteristics of random access memory, whose data does not disappear when the autonomous capture station is deactivated (mass storage). This makes the autonomous capture station more reliable, for example, when confronted with a potential break in a regular electrical energy supply of an isolated zone.

According to another embodiment, the programming module is adapted to interface with at least one data storage sub-module and at least one first application layer is adapted to control at least a partial erasure of frame headers stored by the data storage sub-module according to at least one first predetermined rule.

This embodiment permits optimization of a volume of the data storage sub-module, to permit its autonomous operation to be prolonged in time without reaching a capacity of the data storage sub-module.

According to another embodiment, the programming module includes at least one second application layer adapted to control storage of frame headers by the data storage sub-module according to at least one second predetermined rule.

According to another embodiment, the programming module includes at least one third application layer adapted to control transmission by the transmission module of frame headers captured by the capture module according to at least a third predetermined rule.

According to another embodiment, a data storage sub-module is programmed to store one or more rules from among the following: (a) the first predetermined rule; (b) the second predetermined rule; and/or (c) the third predetermined rule.

According to another embodiment, at least the programming module is addressable by utilizing a location identifier adapted to provide an indication of identification specific to the programming module.

This embodiment allows for parameterization and/or updating of the autonomous capture station from, for example, a remote analysis device.

According to another embodiment, the system according to the invention includes at least one second transmission module remote from the autonomous capture station and communicatively coupled to the communication module.

This embodiment permits the system to be adapted to, for example, a single communication module guaranteeing a link between a plurality of local networks and the global network.

According to another embodiment, the communication module is adapted to communicate according to at least one of: (a) satellite communication; (b) wireless communications; and (c) wired communication.

This embodiment concretizes a selective characteristic of the communication module to use one or several gateways (satellite, wire network, wireless network) to guarantee communication between the local network and the remote network.

According to another embodiment, the statistical analysis module is programmed to automatically perform a statistical analysis according to predefined criteria.

According to another embodiment, the statistical analysis module is adapted to determine: a peak cell rate for a predetermined period of time, an average rate for a predetermined period, a quantity of information exchanged during a predetermined period of time, a temporal profile of a rate, a quantity of information exchanged according to different protocols for a predetermined period, or a temporal profile of protocol use.

According to another embodiment, the local network is a backbone including switching equipment communicatively coupled to at least one of: the capture module, the transmission module, and the programming module.

According to another embodiment, the local network includes a radiofrequency binding post for local users, connected to switching equipment.

According to another embodiment, the statistical analysis module is adapted to generate a spreadsheet file including the results of performed statistical analysis.

According to another embodiment, the statistical analysis module includes an interface permitting identification of at least one local network among a plurality of local networks linked to the remote network.

According to another embodiment, the statistical analysis module includes an interface permitting the choice of a temporal band to which frame headers belong.

According to another embodiment, the local network includes at least one multimedia station.

According to another embodiment, the multimedia station and the autonomous capture station are merged.

This embodiment has the added benefit of integrating the autonomous capture station into the mobile or fixed multimedia station such as, for example, a personal computer, a portable telephone, a Personal Digital Assistant, a digital video broadcasting station compatible with a DVB standard, or a telecommunication station compatible with technologies such as the Blackberry.

Other characteristics and benefits of the invention will emerge clearly from the description below, by way of example and not limiting in any way, referring to the attached drawings:

### BRIEF DESCRIPTION OF THE DRAWINGS

FIG. 1 illustrates schematically a system implementing the invention;

FIG. 2 illustrates different elements implemented for the local network and for a satellite terminal operator;

FIG. 3 illustrates a capture module implemented for a backbone;

FIG. 4 illustrates a capture module implemented for an isolated local network;

FIG. 5 illustrates an example of an integrated module connected between a satellite terminal and a switch;

FIG. 6 illustrates a first example of a report generated following a statistical analysis;

FIG. 7 illustrates a second example of a report generated following a statistical analysis;

FIG. 8 illustrates a third example of a report generated following a statistical analysis;

FIG. 9 represents a diagram of the operation of one embodiment of the system according to the invention.

### DETAILED DESCRIPTION

The invention proposes to capture frame headers according to predefined conditions, and to transmit captured headers by way of the satellite connection and to perform a statistical analysis of headers in a remote device analysis.

A statistical analysis of the local network traffic is therefore accomplished without requiring intervention of a technician for the local network.

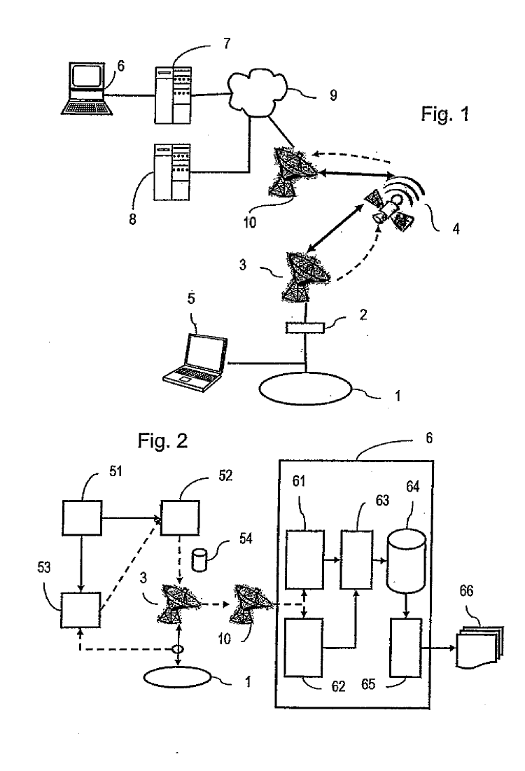

FIG. 1 illustrates a system implementing the invention. A local network 1 not equipped with xDSL services is connected by way of communication equipment 2 from a service provider to a satellite terminal 3. The satellite terminal 3 communicates by way of a satellite 4 with another satellite terminal 10 connected to a network 9 such as the Internet. The local network 1 can therefore communicate with stations or servers 8 accessible by way of the Internet. A station 5 captures IP frame headers transmitted by way of satellite terminal 3 as a function of predefined conditions, for example previously programmed conditions.

Station 5 transmits the headers captured by way of satellite terminal 3. Thus, a satellite link enables both guarantee of communication of local network 1 and the transmission of captured headers. The captured headers are received by a collecting server 7, for example an FTP server. Analysis device 6 analyzes the captured frame headers and extracts information integrated into a database. This information includes, for example, rising and lowering rates, volumes of traffic exchanged, protocols used, and volumes of satellite communication headers of local network 1. Analysis device 6 then performs a statistical analysis on the information in the database according to predefined criteria.

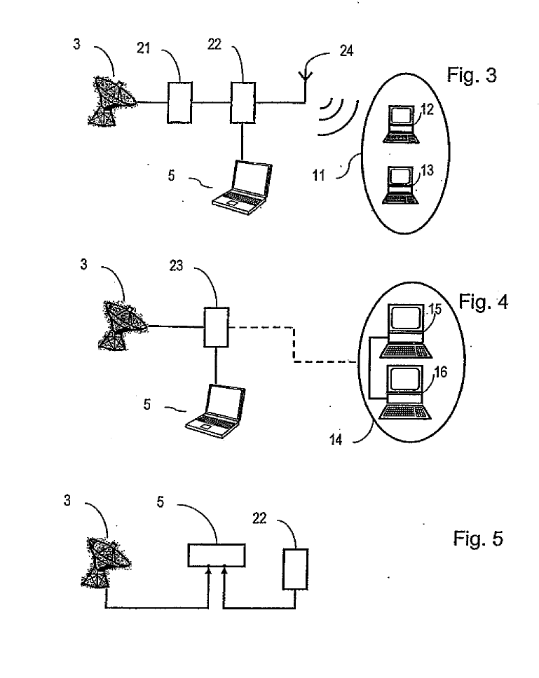

FIG. 2 details more precisely the structure of capture station 5 and analysis device 6. Station 5 presents capture module 53 adapted to capture frame headers exchanged by network 1 by way of satellite terminal 3. Capture module 53 stores headers of these frames. Frame headers captured by capture module 53 are controlled by a programming module 51 as a function of predefined conditions and are transparent for users of local network 1. The frames captured by capture module 53 are provided to transmission module 52. Programming module 51 controls the transmission of captured headers 54 by way of transmission module 52 as a function of predefined conditions. Captured headers 54 are for example sent according to FTP protocol and edited in a compatible file format in transmission module 52.

Capture module 53 may be implemented by way of software such as Winpcap, distributed by Turin Polytechnic Institute. Programming module 51 and transmission module 52 may be installed by programs executed on station 5.

Examples of predefined capture conditions may be prior time parameterization, for example programming predefined hours, days or weeks of frame headers capture. Detection of specific events, such as communication incidents, may also trigger the capture of frame headers.

Analysis device 6 receives captured headers 54. As an added advantage, the captured headers are used to create or enrich one or more databases. Analysis device 6 includes, for example, processing module 61 extracting rate and volume information from the headers and processing module 62 extracting information from header protocols. Processing module 63 edits the extracted information to enrich database 64. Processing module 63 may be implemented in software sold as Ethereal by the Ethereal Company. Database 64 may contain information relative to one or more local networks. Database 64 may consist of, for example, information identifying a local network, defining its rate and/or the volume of data exchanged at a given date and time, protocols used at a given rate or time, or the identification of rates entering and exiting at a given time.

Statistical analysis module 65 presents a user interface permitting definition of types of statistical analyses required. The user interface may in particular enable the definition of periods for which a statistical study should be conducted, the identification of one or several local networks that should be subject to the same statistical study, the type of information contained in a statistical analysis report, or its format. The analysis module 65 may be programmed to perform statistical analyses under predefined conditions. Statistical analysis module 65 may be programmed to perform a statistical analysis at regular intervals or when particular communication conditions of a local network occur.

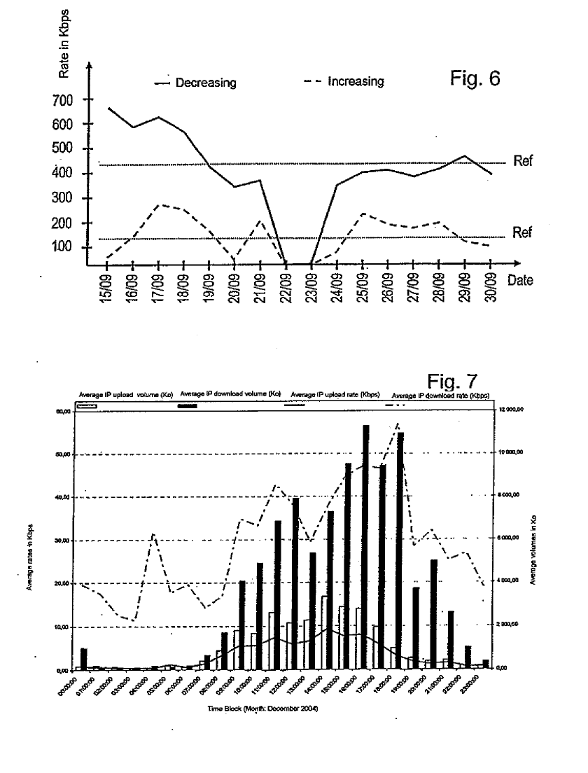

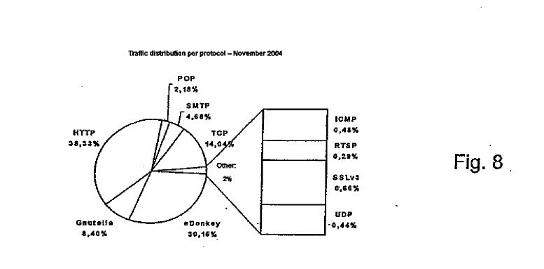

Analysis module 65 may generate statistical analysis results reports 66 including files intended to be read by a spreadsheet program and capable of presenting graphic representations of performed analyses. FIG. 6 illustrates a graphical representation of rates present according to an example of a results analysis report 66. The graphical representation illustrates the day by day descending and rising peak rates and compares them to reference values. A file may be generated per type of statistical analysis performed. FIG. 7 illustrates a graphic representation of descending and rising rates and volumes for different timetables, according to another example of an analysis results report 66. FIG. 8 illustrates a graphic representation of the proportion of use of different protocols during a given period according to another example of an analysis results report 66.

Analysis results reports 66 may, for example, provide the following information:
rising and descending rates;
peak IP rates and/or means of exchange with a local network during a predefined period;
volumes entering and/or exiting from exchanges with the local network during a predefined period;
a daily time profile of exchanges entering and/or exiting;
a time profile of traffic for different protocols. Over a predetermined period a proportion or volume of use (in percentage of the number of frames or data volume for example) of a given protocol may be determined. As a function of the number of captured headers, we may perform an analysis of a more or less significant periods, examine a punctual problem, or determine traffic trends.

FIG. 3 illustrates an example of the implementation of a capture station 5, in the event that satellite 3 serves a backbone network, i.e. including routing equipments 21 and switching equipments 22 from a service provider, designed to serve one or several local networks 11. In the illustrated example, a Wifi access point 24 serves local user network 11 including stations 12 and 13. Capture station 5 may advantageously be connected to a switch 22 of a satellite terminal 3 operator.

FIG. 4 illustrates an example of implementation of a capture station 5 when the satellite terminal 3 serves an isolated site, such as a small business or an individual not capable of being served by Wifi access point 24 of the backbone. The illustrated isolated site benefits from isolated satellite access by way of satellite terminal 3, typically presenting more modest performances than the satellite terminal of the backbone illustrated in FIG. 3. Capture station 5 may advantageously be connected to an Ethernet port of a hub 23 connecting terminal 3 to local network 14 comprising stations 15 and 16.

Capture station 5 illustrated schematically in FIG. 5 is an autonomous integrated module. Capture station 5 is connected between satellite terminal 3 and switching equipment 22 of a service provider. Capture station 5 may integrate a motherboard such as the model sold under reference Net4801-50 by Soekris Engineering Company, a 2.5 inch hard disk storing the operating system and temporarily capture files before their transmission to collecting server 7. Capture station 5 also includes a case with an electric power supply adapter. The applicant performed tests with capture station 5 presenting the following characteristics:
processor sold under Géode NSC SC1100 reference, synchronized at 266 MHz;
random access memory 128 Mb SDRAM welded to the motherboard;
4 Mb of BIOS memory.

Capture station 5 may also be provided with a takeover module (not illustrated), in order to permit parameterization or updating of this station from a remote analysis device. Capture station 5 may also be supplied with a programmable uploading module, uploading a module update or capture conditions under predetermined conditions.

Transmission module 52 and capture module 53 may have a cellular architecture, for example, in several layers comprising hardware and/or software. For example, capture module 53 may contain at least one reading sub-module (not represented in FIG. 2) adapted to read frame headers 54 exchanged between local network 1 and remote network 9 by way of the communication module 3, 4, and 10.

Capture module 53 may also include at least one data storage sub-module (not represented in FIG. 2) adapted to store frame headers 54 exchanged between local network 1 and remote network 9 by way of communication module 3, 4, 10. The data storage sub-module may be formed, for example, by at least one flash memory.

Programming module 51 may also have a cellular architecture, for example, in several layers comprising hardware and/or software. For example, programming module 51 may include:
at least one first application layer to control at least partial erasure of frame headers 54 stored by the data storage sub-module according to at least one first predetermined rule, and/or
at least one second application layer adapted to control storage of frame headers 54 by the data storage sub-module according to at least one second predetermined rule, and/or
at least one third application layer adapted to control transmission by transmission module 52 of frame headers 54 captured by capture module 53 according to at least one third predetermined rule.

Each of the three predetermined rules mentioned above may be constructed by combining different criteria relative to:
time parameterization, with a corresponding operation (respectively erasure, storage, transmission) being executed, for example, at least once per hour, per day, per week, per month, etc., and/or
dynamic structural parameterization, with a corresponding operation being executed as a function of one or more representative parameters, for example:
   traffic (no traffic representative of a window of inactivity, traffic less than a predefined threshold) between local network 1 and remote network 9,
   availability of communication module 3, 4, 10
   types of protocols used, for example, User Datagram Protocol (UDP), Internet Protocols such as Transmission Control Protocol (TCP) and Internet Protocol (IP) for communications between local network 1 and remote network 9,
   types of transmission standards used for communications between local network 1 and remote network 9,
   state of charge of a battery and/or an electric power supply from autonomous capture station 5,
   predetermined filling rate of the data storage sub-module, and/or
selective parameterization, with a corresponding operation being triggered by a specific event such as, for example:
   communication incidents,
   a predefined communication priority level between local network 1 and remote network 9 identifiable with the aid of a corresponding field in frame headers 54.

In another embodiment, the system according to the invention includes programming module 51 containing a first application layer to control total erasure of frame headers 54 stored by the data storage sub-module according to at least one first predetermined rule.

Programming module 51 may also include at least one data storage sub-module formed, according to one example, by at least one other flash memory.

In another embodiment, the system according to the invention includes programming module 51 is addressable by, for example, by the analysis device 6, by utilizing a location identifier specific to programming module 51.

In another embodiment, other modules forming the autonomous capture station 5, for example, the capture module 53 and/or the transmission module 52, may be addressable by, for example, the analysis device 6, by utilizing respective location identifiers specific to these modules.

Each module 51, 52, 53 forming autonomous capture station 5 may include a specific application layer integrated into the hardware, for example, an application layer referred to as “firmware”, to store and/or implement data representative of predetermined rules, predefined capture conditions, updates addressed by remote network 9 to one or more modules 51, 52, 53 forming autonomous capture station 5.

In another embodiment, communication module 3, 4, 10 is adapted to communicate according to: (a) satellite communication; (b) wireless communication, (c) wired communication. Communication module 3, 4, 10 may be previously programmed to selectively use any one of the methods of communication as a function of different predetermined criteria, for example:
A presence of terrestrial communication infrastructures in at least partial operating mode in the isolated zone,
A possibility of establishing satellite communication,
Types of protocols used for communication between local network 1 and remote network 9,
Types of transmission standards used for communication between local network 1 and remote network 9.

In another embodiment, the system according to the invention includes at least one second transmission module remote from autonomous capture station 5 and linked to communication module 3, 4, 10.

In another embodiment, the system according to the invention may include of a plurality of autonomous capture stations 5 communicating or not between one another, with each of these stations 5 being adapted, for example, to a specific task or a specific local network 1.

In another embodiment, at least transmission module 52 includes at least one coding sub-module (not represented in FIG. 2) to code, for example, in a bit stream, frame headers 54 captured by capture module 53 and transmitted from capture module 53 to transmission module 52.

Transmission module 52 may also include at least one selective transmission sub-module (not represented in FIG. 2). Thus, coded frame headers 54 may be sent selectively, for example, by packets or in continuous bit streams, to communication module 3, 4, 10 and collecting server 7 in addition to the normal traffic between local network 1 and remote network 9. To prevent any saturation of communication module 3, 4, 10, coded frame headers 54 may be sent to remote network 9 in a delayed-repeater mode, for example, during the night in the isolated zone.

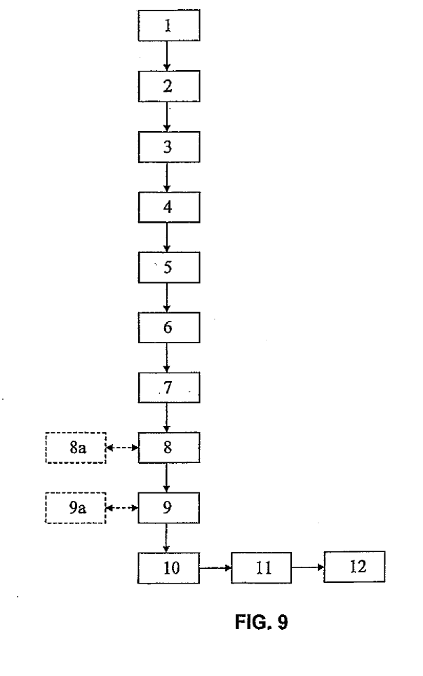

The operation of one embodiment of the information transmission system according to the invention described above is illustrated with the aid of FIGS. 9, 1 and 2.

Step 1 includes automatic and completely autonomous activation, at a given moment, for example following an activation order emanating from programming module 51 of autonomous capture station 5 located in the isolated zone.

Step 2 includes reading, following a corresponding order from programming module 51, by reading sub-module of capture module 53 frame headers of real traffic between local network 1 and remote network 9 by way of satellite communication module 3, 4, 10.

Step 3 includes storing, following a corresponding order from programming module 51, by the data storage sub-module (not represented in FIG. 2) of capture module 53 of frame headers 54 of real traffic between local network 1 and remote network 9 by way of satellite communication module 3, 4, 10.

Step 4 includes transferring, following a corresponding order from programming module 51, captured frame headers 54 from the data storage sub-module to the coding sub-module of transmission module 52.

Step 5 includes coding, following a corresponding order from programming module 51, by the coding sub-module, captured frame headers 54 in a bit stream.

Step 6 includes transmission, following a corresponding order from programming module 51, by the selective transmission sub-module in continuous bit stream captured frame headers 54 to collecting server 7 of remote network 9 via satellite communication module 3, 4, 10, for example, with the aid of a File Transfer Protocol.

Step 7 includes automatic activation of analysis device 6 linked to the collecting server 7, for example, at reception of the captured headers 54 transmitted by the selective transmission module.

Step 8 includes extracting, with the aid of processing module 61, called a first processing module 61 of analysis device 6, of rate and volume information from captured headers 54. Optionally, step 8 may include sub-step 8a decoding the continuous bit streams with headers 54 of captured frames, with the aid, for example, of a first decoding sub-module (not represented in FIG. 2) of first processing module 61.

Step 9 includes extracting with the aid of processing module 62, called a second processing module 62 of analysis device 6, information from the protocol headers. Optionally, step 9 may include sub-step 9a decoding continuous bit streams with captured frame headers 54, with the aid, for example, of a second decoding sub-module (not represented in FIG. 2) of second processing module 62.

It should be noted that in another embodiment, the first decoding sub-module of first processing module 61 and the second decoding sub-module of second processing module 62, are merged.

Step 10 includes editing information extracted by first and second processing modules 61, 62, to enrich database 64 of analysis device 6.

Step 11 includes choosing with the aid of analysis module 65 of analysis device 6 analysis report generation parameters 66 (choice of isolated sites, choice of a temporal band, choice of statistics).

Step 12 includes automatically generating statistical files using analysis module 65 and graphics forming analysis report 66.

1. An information transmission system, comprising:
at least one local network linked via a communication module to a remote network remote from the local network, wherein the remote network includes an analysis device that includes at least one statistical information analysis module stemming from the local network;
wherein the information transmission system includes at least one autonomous capture station communicatively coupled to the local network, wherein the autonomous capture station comprises:
a capture module adapted to capture frame headers exchanged between the local network and the remote network by way of a communication module, wherein capture of the frame headers operates transparently for users of the local network,
a transmission module adapted to transmit to the remote network by way of the communication module the frame headers captured by the capture module,
a programming module adapted to autonomously control capture of frame headers by the capture module and the transmission of captured frame headers by the transmission module according to at least one predefined condition, and
wherein information originating from the local network destined for the statistical analysis module includes the frame headers transmitted by the transmission module.

2. The information system of claim 1, wherein the capture module includes at least one reading sub-module adapted to read frame headers exchanged between the local network and the remote network by way of the communication module.

3. The information system of claim 1, wherein the autonomous capture station further comprises:
at least one data storage sub-module constructed to store information related to the frame headers exchanged between the local network and the remote network by way of the communication module.

4. The information system of claim 3, wherein the data storage sub-module includes at least one flash memory.

5. The information system of claim 3 includes wherein the programming module includes at least one first application layer adapted to control at least partial erasure of information related to the frame headers stored by the data storage sub-module according to at least one first predetermined rule.

6. The information system of claim 3, wherein the programming module includes at least one second application layer adapted to control storage of information relating to the frame headers by the data storage sub-module according to at least one second predetermined rule.

7. The information system of claim 3, wherein the programming module includes at least one third application layer adapted to control transmission by the transmission module of information relating to the frame headers captured by the capture module according to at least one third predetermined rule.

8. The information system of claim 1, further comprising:
at least one the data storage sub-module adapted to store at least one rule among the following rules: (a) a first predetermined rules, (b) a second predetermined rule, and (c) a third predetermined rule.

9. The information system of claim 1, wherein at least the programming module is addressable by utilizing a location identifier adapted to provide an indication of identification specific to the programming module.

10. The information system of claim 1, further comprising at least one second transmission module remote from the autonomous capture station and communicatively coupled to the communication module.

11. The information system of claim 1, wherein the communication module is adapted to communicate according to at least one of: (a) satellite communication means; (b) wireless communication; and (c) wired communication.

12. The information system of claim 1, wherein the statistical analysis module is programmed to automatically perform a statistical analysis according to at least one predefined criteria.

13. The information system of claim 1, wherein the statistical analysis module is adapted to determine one or more characteristics selected from the group consisting of:
a peak rate for a predetermined period;
an average rate for a predetermined period;
a quantity of information exchanged for a predetermined period;
a temporal profile of one or more rates;
a quantity of information exchanged according to different protocols for a predetermined period; and
a temporal profile of protocol use.

14. The information system of claim 1, wherein the local network is a backbone including at least one switching device communicatively coupled to at least one of: the capture module, the transmission module, and the programming module.

15. The information system of claim 1, wherein the local network includes a radiofrequency binding post, connected to at least one switching device.

16. The information system of claim 1, wherein the statistical analysis module is adapted to generate a spreadsheet file including the results of at least one statistical analysis.

17. The information system of claim 1, wherein the statistical analysis module includes an interface permitting identification of a local network among a plurality of local networks communicatively coupled with the remote network.

18. The information system of claim 1, wherein the statistical analysis module includes an interface permitting a selection of a temporal band.

19. The information system of claim 1, wherein the local network is formed by at least one multimedia workstation.

20. The information system of claim 1, wherein the multimedia workstation and autonomous capture station are merged.
